(19) United States
(12) Patent Application Publication
(10) Pub. No.: US 2026/0131661 A1
(43) Pub. Date: May 14, 2026

(54) MULTIPLE-REDUNDANT POWER SUPPLY FOR BATTERY SAFETY SYSTEM

(71) Applicant: Rivian IP Holdings, LLC, Irvine, CA (US)

(72) Inventors: Shiju WANG, Irvine, CA (US); Long Phi HUYNH, Brea, CA (US); Ajay KUMAR, Phoenix, AZ (US)

(21) Appl. No.: 19/384,207

(22) Filed: Nov. 10, 2025

Related U.S. Application Data
(60) Provisional application No. 63/718,479, filed on Nov. 8, 2024.

(51) Int. Cl. B60L 3/00; B60L 1/14; H01M 50/574; H02J 1/08; H02J 7/34

(52) U.S. Cl. CPC B60L 3/0046; B60L 1/14; H01M 50/574; H02J 1/086; H02J 7/345; B60L 2210/10; H01M 2220/20

(57) ABSTRACT

A vehicle includes a high-voltage and a battery safety system configured to disconnect the high-voltage battery in response to an unsafe condition. The vehicle includes a first voltage domain with a corresponding voltage and ground plane, the battery safety system being in the first voltage domain. The vehicle includes a second voltage domain supplying power to components of the vehicle such as actuators, lights, sensors, or controllers. A first DCDC supplies power from the high-voltage battery to the first voltage domain and a second DCDC supplies power from the high-voltage battery to the second voltage domain. A backup DCDC supplies power from the second voltage domain to the first voltage domain in response to failure of the first DCDC. The first DCDC may also supply power to the second voltage domain. A capacitor in the second voltage domain may supply power to the battery safety system as well.

### RELATED APPLICATION

This application claims priority to U.S. Provisional Application Ser. No. 63/718,479 filed Nov. 8, 2024, and entitled MULTIPLE-REDUNDANT POWER SUPPLY FOR BATTERY SAFETY SYSTEM, which is hereby incorporated herein by reference in its entirety.

### SUMMARY

In one aspect, a system includes a high-voltage battery having a voltage of at least 200 volts at a full state of charge (SOC). The system includes a battery safety system configured to disconnect the high-voltage battery in response to an unsafe condition. The system includes a first voltage domain, the battery safety system being in the first voltage domain. A first direct current to direct current converter (DCDC) is configured to supply power to the first voltage domain from the high-voltage battery. The system further includes a second voltage domain and a backup DCDC configured to supply power from the second voltage domain to the first voltage domain in response to failure of the first DCDC.

In some embodiments, the battery safety system includes one or more pyro drivers each configured to detonate a pyrotechnic device.

In some embodiments, the battery safety system includes a battery monitor.

In some embodiments, the first voltage domain and the second voltage domain have different nominal voltages.

In some embodiments, a nominal voltage of the first voltage domain is larger than a nominal voltage of the second voltage domain.

In some embodiments, the first voltage domain and the second voltage domain have different ground planes.

In some embodiments, the first voltage domain and the second voltage domain have nominal voltages less than 50 volts.

In some embodiments, the system further includes a second DCDC configured to supply power to the second voltage domain from the high-voltage battery.

In some embodiments, the first DCDC is configured to supply power to both of the first voltage domain and the second voltage domain.

In some embodiments, a maximum sustained output power capacity of the second DCDC is at least ten times a maximum sustained output power capacity of the first DCDC.

In some embodiments, the system further includes a low voltage battery configured to supply power to the second voltage domain, the low voltage battery having a voltage of less than 50 volts at a full SOC.

In some embodiments, the system further includes a plurality of vehicle components coupled to the second voltage domain.

In some embodiments, the plurality of vehicle components includes at least one of actuators, lights, sensors, or controllers.

In some embodiments, the system further includes a capacitor in the first voltage domain, the capacitor configured to supply power to the battery safety system upon failure of the backup DCDC.

In some embodiments, the capacitor is connected to the second voltage domain and configured to supply power to the battery safety system through the backup DCDC.

In another aspect, a vehicle includes a high-voltage battery having a voltage of at least 200 volts at a full state of charge (SOC). The vehicle includes one or more drive units configured to propel the vehicle via power received from the high-voltage battery. A battery safety system is configured to disconnect the high-voltage battery in response to an unsafe condition. The vehicle includes a first voltage domain, the battery safety system being in the first voltage domain. The vehicle includes a first direct current to direct current converter (DCDC) configured to supply power to the first voltage domain from the high-voltage battery. The vehicle includes a second voltage domain and a second DCDC configured to supply power to the second voltage domain from the high-voltage battery. The vehicle includes a plurality of vehicle components coupled to the second voltage domain, the plurality of vehicle components including at least one of actuators, lights, sensors, or controllers. The vehicle includes a backup DCDC configured to supply power from the second voltage domain to the first voltage domain in response to failure of the first DCDC.

In some embodiments, the battery safety system includes one or more pyro drivers each configured to detonate a pyrotechnic device.

In some embodiments, the first DCDC is configured to supply power to both of the first voltage domain and the second voltage domain. A maximum sustained output power capacity of the second DCDC may be at least ten times a maximum sustained output power capacity of the first DCDC.

In some embodiments, the vehicle includes a low voltage battery configured to supply power to the second voltage domain, the low voltage battery having a voltage of less than 50 volts at a full SOC.

In some embodiments, the vehicle includes a capacitor in the first voltage domain, the capacitor configured to supply power to the battery safety system upon failure of the backup DCDC, the capacitor being connected to the second voltage domain and configured to supply power to the battery safety system through the backup DCDC.

### BRIEF DESCRIPTION OF THE DRAWINGS

FIG. 1A illustrates an example vehicle in accordance with certain embodiments.

FIG. 1B illustrates a chassis of a vehicle in accordance with certain embodiments.

FIG. 2A is a schematic block diagram of components of a vehicle in accordance with certain embodiments.

FIG. 2B is a schematic block diagram of alternative components of a vehicle in accordance with certain embodiments.

FIG. 3 illustrates a power supply for a battery safety system in accordance with certain embodiments.

### DETAILED DESCRIPTION

In an electric vehicle, it is important to disconnect the high-voltage battery in the case of an accident. An electric vehicle may therefore include a battery safety system that will automatically disconnect the high-voltage battery in certain emergency situations. In some vehicles, the vehicle is not drivable unless the battery safety system is available. The approach described herein provides an improved approach for supplying power to a battery safety system

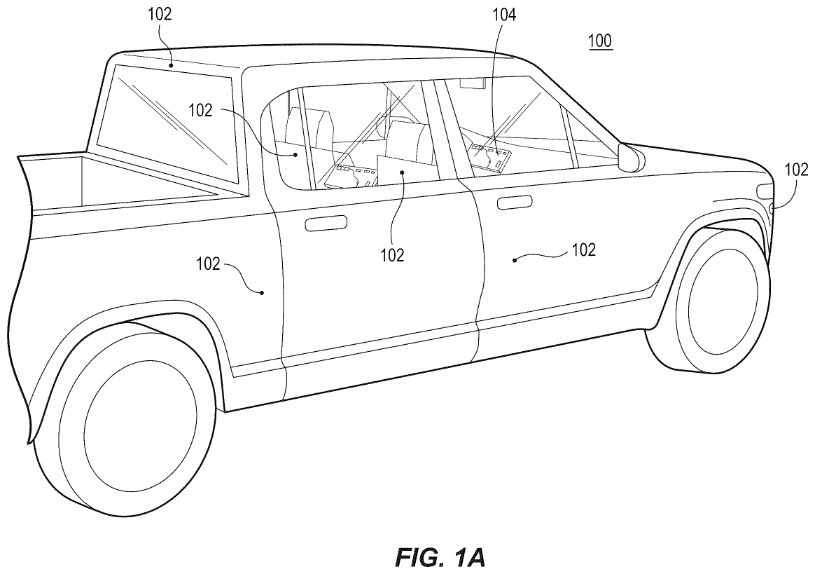

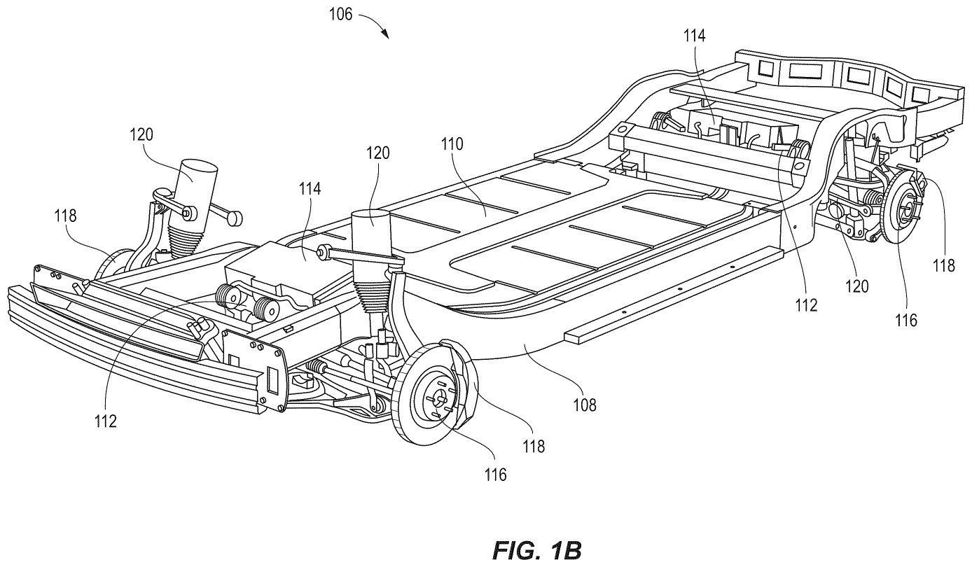

FIG. 1A illustrates an example vehicle 100. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (i.e., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112 configured to propel the vehicle 100. Each drive unit 112 may be formed of an electric motor and possibly a gear reduction drive. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by one or more sets of power electronics 114. The power electronics 114 may include inverters configured to convert direct current (DC) from the battery 110 into alternating current (AC) supplied to the motors of the drive units 112.

The drive units 112 are coupled to two or more hubs 116 to which wheels may mount. Each hub 116 includes a corresponding brake 118, such as the illustrated disc brakes. The drive units 112 or other component may also provide regenerative braking. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B and in the discussion below, the vehicle 100 is a battery electric vehicle. However, the systems and methods disclosed herein may be used for any type of vehicle, including vehicles powered by an internal combustion engine (ICE), hybrid drivetrain, hydrogen fuel cell drivetrain, or other type of drivetrain that requires heating in preparation for use, such as diesel engines.

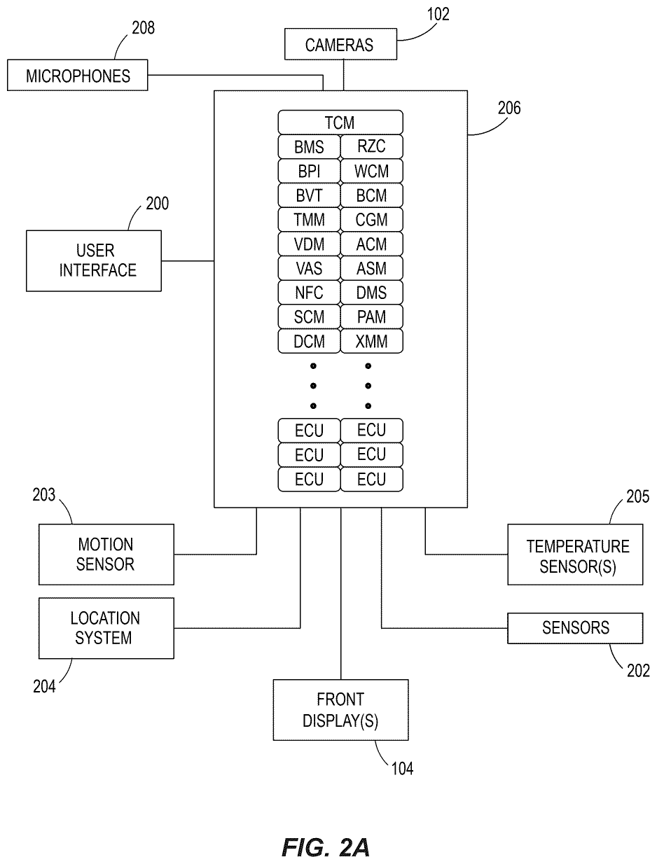

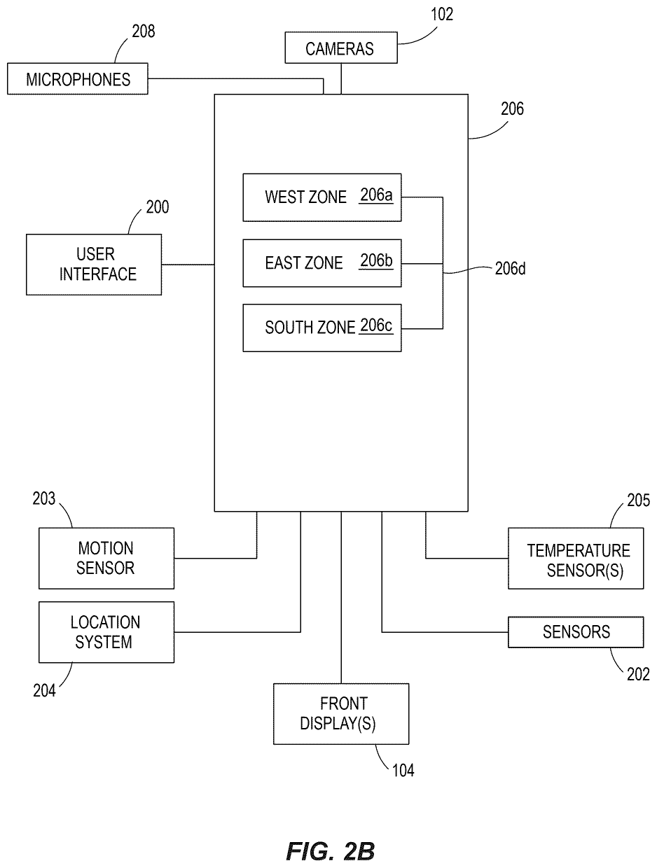

FIG. 2A illustrates example components of the vehicle 100 of FIG. 1A. As shown in FIG. 2A, the vehicle 100 includes the cameras 102, the one or more front displays 104, a user interface 200, one or more sensors 202, a motion sensor 203, and a location system 204. The one or more sensors 202 may include ultrasonic sensors, radio detection and ranging (RADAR) sensors, light detection and ranging (LIDAR) sensors, or other types of sensors. The location system 204 may be implemented as a global positioning system (GPS) receiver. The user interface 200 allows a user, such as a driver or passenger in the vehicle 100, to provide input.

The components of the vehicle 100 may include one or more temperature sensors 205. The temperature sensors 205 may include sensors configured to sense an ambient air temperature, temperature of the battery 110, temperature of power electronics 114, temperature of each drive unit 112 and/or each motor of each drive unit 112, or the temperature of any other component of the vehicle 100.

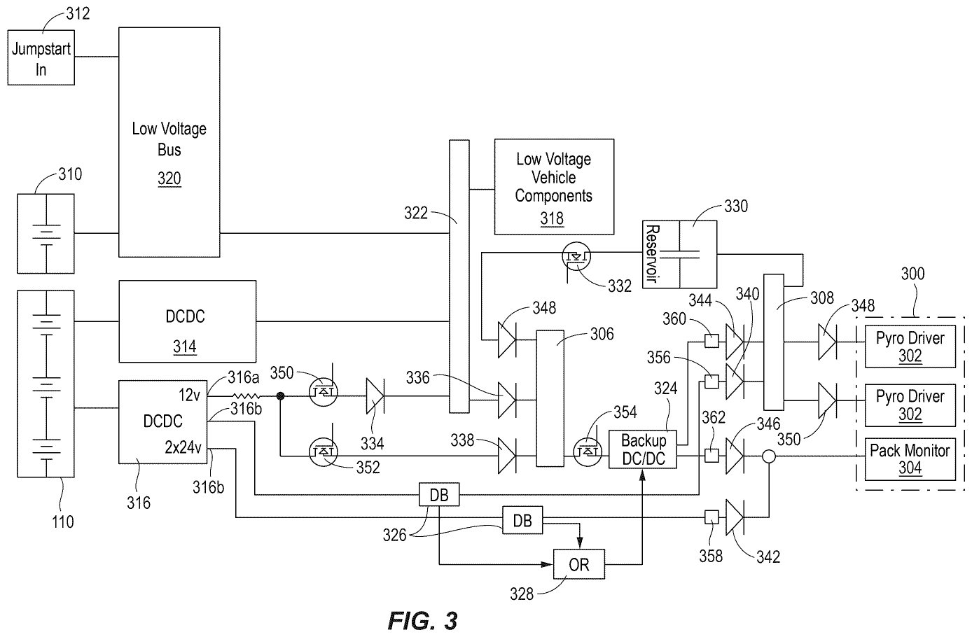

A control system 206 executes instructions to perform at least some of the actions or functions of the vehicle 100, including the functions described below. For example, as shown in FIG. 2, the control system 206 may include one or more electronic control units (ECUs) configured to perform at least some of the actions or functions of the vehicle 100, including the functions described in relation to FIG. 3. In certain embodiments, each of the ECUs is dedicated to a specific set of functions. Each ECU may be a computer system and each ECU may include functionality described below in relation to FIG. 3.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle's communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102 and sensors 202. The sensor signals collected by the CGM ECU are then communicated to the appropriate ECUs for performing, for example, the operations and functions described in relation to FIG. 3.

The control system 206 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU. If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 208, etc.) to the TCM ECU.

Referring to FIG. 2B, in some embodiments, the control system 206 may be implemented as a plurality of zonal controllers 206a, 206b, 206c. Each zonal controller 206a, 206b, 206c may control a subset of systems of the vehicle. The subset of systems controlled by each zonal controller 206a, 206b, 206c may be generally assigned based on location within the vehicle 100. For example, a west zonal controller 206a may control systems on a driver side of the vehicle 100, an east zonal controller 206b may control systems on a passenger side of the vehicle 100, and a south zonal controller 206c may control systems in a rear portion of the vehicle. Each zonal controller 206a, 206b, 206c may implement a portion of the functions ascribed to the ECUs of the control system 206 of FIG. 2A. The functions of the ECUs may be distributed among the zonal controller 206a, 206b, 206c such that only one zonal controller 206a, 206b, 206c implements the functions of each ECU. Alternatively, the functions of an ECU may be duplicated across multiple zonal controllers 206a, 206b, 206c, each zonal performing the functions of the ECU for the portion of the vehicle to which that zonal controller 206a, 206b, 206c is assigned.

The zonal controllers 206a, 206b, 206c may be connected to one another by a network 206d, such as an Ethernet network, controller area network (CAN), or other type of network.

Referring to FIG. 3, a battery safety system 300 is included in the vehicle 100 to disconnect the battery 110 from cabling of the vehicle 100 (e.g., cable(s) connecting the battery 110 to the one or more drive units 112) in the event of an accident. The battery safety system 300 may include one or more pyro drivers 302. Each pyro driver may control power to a small pyrotechnic device, e.g., explosive, that can be detonated to either (a) disconnect a port of the battery 110 from the battery, one or more cables being connected to the port or (b) server a cable connected to the battery 110. The implementation of the pyro driver, the explosive device, and the configuration of the battery 110 and cabling may be according to any approach known in the art and according to any safety standard known in the art.

The battery safety system 300 may include a pack monitor 304 (e.g., a battery monitor for the battery 110). The pack monitor 304 may be configured to monitor the state of the battery 110 and evaluate isolation of the battery 110, such as shorting or other anomalous electrical connections to the output terminals of the battery 110. The pack monitor 304 may invoke the pyro drivers 302 to activate their corresponding pyrotechnic devices in response to detecting an accident or other unsafe condition relating to the battery 110.

The battery safety system 300 must receive electrical power in order to function. In some embodiments, the control system 206 includes interlocks that do not allow the vehicle 100 to be driven unless the battery safety system 300 is supplied with power. In the same or other embodiments, the control system 206 includes interlocks that do not allow the vehicle 100 to be driven unless the battery safety system 300 is supplied with power from multiple sources.

In the approach described herein, multiple redundant power sources are available to supply power to the battery safety system 300. In some embodiments, the battery safety system 300 is enabled to receive power from multiple voltage domains. Each voltage domain may have a corresponding ground plane and voltage and may be isolated from the other voltage domain. For example, the battery 110 may have a floating ground that may, for example, fall as low as 200 volts or more. The first voltage domain may have a ground plane of 0 volts. The second volage domain may have the same ground plane as the battery 110 or different ground plane than both the battery 110 and the first voltage domain. As used herein, “0 volts” may be understood as a voltage of the conductive members of the chassis 106 of the vehicle 100.

In the illustrated embodiment, each voltage domain is a low voltage domain relative to the voltage of the battery 110. For example, at a full state of charge (SOC) the battery 110 may have an output voltage of at least 200, at least 300, at least 400 volts. In contrast, the multiple voltage domains may have voltages of 50 volts or less, such as 48 volts or less. For example, a first voltage domain may have a nominal voltage of 12 volts, and a second voltage domain has a larger nominal voltage, such as 24 volts. Voltages may vary from the nominal voltages, such as +/−2 volts.

In the illustrated embodiment, a first voltage domain is implemented by components coupled to a voltage domain bus 306 and the second voltage domain is implemented by components coupled to a voltage domain bus 308. In the illustrated embodiment, the battery safety system 300 is in the second voltage domain and is connected to the voltage domain bus 308.

The voltage domain bus 306 may be coupled to a low voltage battery 310 and a jumpstart port 312. The low voltage battery 310 may have a voltage of 50 volts or less at a full SOC, such as a nominal voltage of 48 volts, 24 volts, or 12 volts at a full SOC. The voltage domain bus 306 may receive power from a main direct current to direct current converter (DCDC) 314. The DCDC 314 receives current from the battery 110 and outputs current to the voltage domain bus 306 at the nominal voltage of the first voltage domain, e.g., 12 volts.

In some embodiments, the vehicle may include an always on DCDC 316. The DCDC 316 may remain on and supplying power even when the vehicle 100 is powered down and is not being driven. The DCDC 314 may have a maximum sustained output power capacity that is much greater than that of the DCDC 316, such as at least 10, 20, 50, or 100 times greater. The maximum sustained output power capacity of the DCDC 316 may be less than 150 Watts, less than 100 Watts, less than 80 Watts, or about 50 Watts.

In some implementations, the DCDC 314 is powered only when a main contactor of the battery 110 is closed, e.g., when the vehicle is on and in a state that can be driven. In contrast, the DCDC 316 is connected to the battery 110 in bypass of the main connector and therefore will supply power regardless of the state of the main connector.

In the illustrated embodiment, the DCDC 316 has multiple outputs, such an output 316a at the nominal voltage of the first voltage domain (e.g., 12 volts) and one or more outputs 316b at the nominal voltage of the second voltage domain (e.g., 24 volts). In the illustrated embodiment, the DCDC 316 has two outputs 316b at the nominal voltage of the second voltage domain.

The DCDC 314 and DCDC 316 may power low voltage vehicle components 318 of the vehicle 100, such as actuators (e.g., windshield wiper actuators, door handle actuators, relay actuators, etc.), lights (e.g., headlights, cabin lights, etc.), the control system 206 and any components connected thereto (see, e.g., FIGS. 2A and 2B). The low voltage vehicle components 318 of the vehicle 100 may include every electrical component other than the one or more drive units 112 and corresponding power electronics 114. When the vehicle 100 is turned off, the DCDC 316 may power a subset of the low voltage vehicle components 318 that remain active, such as cameras 102 and portions of the control system 206 for monitoring the exterior of the vehicle and components that are used to turn on the vehicle 100.

In the illustrated embodiments, the low voltage battery 310 and jumpstart port 312 are connected to a low voltage bus 320. The low voltage bus 320 and DCDC 314 may be connected to another low voltage bus 322 that is connected to the voltage domain bus 306. The low voltage vehicle components 318 may be connected to the low voltage bus 322. In the illustrated embodiment, the DCDC 316 may connect to the voltage domain bus 306 due to a connection to the low voltage bus 322, e.g., the output 316a may be connected to one or both of the low voltage bus 322 and the voltage domain bus 306.

The voltage domain bus 308 may be connected to one of the one or more outputs 316b. In the illustrated embodiment, one of the outputs 316b is also connected to the pack monitor 304. A backup DCDC 324 may also be connected to the voltage domain bus 308. The backup DCDC 324 is configured to receive power from the first voltage domain and convert the power to the nominal voltage and ground plane of the second voltage domain. The backup DCDC 324 may therefore be connected to the voltage domain bus 306 and therefore be enabled to receive power from any of the voltage sources connected to the voltage domain bus 306: the low voltage battery 310, the jumpstart port 312, the DCDC 314, and the output 316a of the DCDC 316. The DCDC 324 may be implemented as a flyback DCDC. The backup DCDC 324 may provide isolation between the first voltage domain and the second voltage domain.

In some embodiments, the backup DCDC 324 is inactive, e.g., in a low-power sleep state, during normal operation of the vehicle. The backup DCDC 324 may be enabled in response to detecting that the one or more outputs 316b of the DCDC 316 are not connected to the voltage domain bus 308. For example, detection blocks 326 may detect voltage on wires connecting the outputs 316b to the voltage domain bus 308. The outputs of the detection blocks 326 may be input to the backup DCDC 324, such as through a logical OR gate 328. Accordingly, if the output of either of the detection blocks 326 indicates failure, the backup DCDC 324 will be enabled.

In some embodiments, a capacitor 330 is further connected to the voltage domain bus 308. The capacitor 330 will be charged to the voltage of the second voltage domain and will release current onto the voltage domain bus 308 in response to voltage on the domain bus 308 falling below the voltage of the capacitor 330. The capacitor 330 therefore provides yet another redundant voltage source for powering the battery safety system 300. In the illustrated embodiment, the capacitor 330 is additionally coupled to the voltage domain bus 306, such as through a transistor relay 332. In the event that the voltage on the capacitor 330 falls to below a threshold voltage, the transistor relay 332 may open and couple the capacitor 330 to the voltage domain bus 306. The backup DCDC 324 may therefore receive power from the capacitor 330 and convert the power from the capacitor 330 to the nominal voltage and ground plane of the second voltage domain. In this manner, even when the capacitor 330 falls below the nominal voltage of the second voltage domain, the charge of the capacitor 330 may still be used to power the battery safety system 300. The capacitor 330 may store sufficient power during normal operation to power the pyro drivers 302 and pack monitor 304 simultaneously in the event that all other sources of power fail.

Various components may be present to ensure that current flows in proper directions and to avoid unsafe conditions. For example, diode 334 ensures current flows from the output 316a of the DCDC 316 to the low voltage bus 322 and not in the reverse direction. Diode 336 ensures current flows from the low voltage bus 322 to the voltage domain bus 306 and not in the reverse direction. Diode 338 ensures current flows from the output 316a of the DCDC 316 to the voltage domain bus 306 and not in the reverse direction. Diode 340 ensures that current flows from one of the outputs 316b of DCDC 316 to the voltage domain bus 308 and not in the reverse direction. Diode 342 ensures that current flows from the other output 316b of the DCDC 316 to the pack monitor 304 and not in the opposite direction. Diode 344 ensures that current flows from the backup DCDC 324 to the voltage domain bus 308 and not in the opposite direction. Diode 346 ensures that current flows from the backup DCDC 324 to the pack monitor 304 and not in the opposite direction. Diode 348 ensures that current flows from the capacitor 330 to the voltage domain bus 306 and not in the opposite direction.

A transistor relay 350 may detect current flow from the DCDC 316 to the low voltage bus 322 and open in response to the current resulting in excess current, excess voltage, or excess temperature conditions. A transistor relay 352 may detect current flow from the DCDC 316 to the voltage domain bus 306 and open in response to the current resulting in excess current, excess voltage, or excess temperature conditions. A transistor relay 354 may detect current flow from the voltage domain bus 306 to the backup DCDC 324 and open in response to the current resulting in excess current, excess voltage, or excess temperature conditions. A transistor relay 356 may detect current flow from the DCDC 316 to the voltage domain bus 308 and open in response to the current resulting in excess current, excess voltage, or excess temperature conditions. A transistor relay 358 may detect current flow from the DCDC 316 to the pack monitor 304 and open in response to the current resulting in excess current, excess voltage, or excess temperature conditions. A transistor relay 360 may detect current flow from the backup DCDC 324 to the voltage domain bus 308 and open in response to the current resulting in excess current, excess voltage, or excess temperature conditions. A transistor relay 362 may detect current flow from the backup DCDC 324 to the pack monitor 304 and open in response to the current resulting in excess current, excess voltage, or excess temperature conditions. The transistor relay 332 may detect current flow from the capacitor 330 to the voltage domain bus 306 and open in response to the current resulting in excess current, excess voltage, or excess temperature conditions.

In view of the foregoing description, power may be supplied to the battery safety system 300 from the following sources with failover from one source to another in the order listed:
1. The low voltage battery 310 or DCDC 314 or DCDC 316 (all could possibly be active at any given time and lack of one or more does not necessarily indicate failure).
2. The backup DCDC 324.
3. The capacitor 330 through direct coupling to the voltage domain bus 308.
4. The capacitor 330 through the backup DCDC 324.

The approach described herein provides very high redundancy for supplying power to the battery safety system 300 and avoids triggering of interlocks that would make the vehicle 100 undrivable in response to a lack of power to battery safety system 300.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a one or more computer processing devices. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Certain types of storage devices that include these mediums include: diskette, hard disk, random access memory (RAM), read only memory (ROM), erasable programmable read only memory (EPROM or Flash memory), static random access memory (SRAM), compact disc read only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, refers to non-transitory storage rather than transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but the storage device remains non-transitory during these processes because the data remains non-transitory while stored.

What is claimed is:

1. A system comprising:
a high-voltage battery having a voltage of at least 200 volts at a full state of charge (SOC);
a battery safety system configured to disconnect the high-voltage battery in response to an unsafe condition;
a first voltage domain, the battery safety system being in the first voltage domain;
a first direct current to direct current converter (DCDC) configured to supply power to the first voltage domain from the high-voltage battery;
a second voltage domain; and
a backup DCDC configured to supply power from the second voltage domain to the first voltage domain in response to failure of the first DCDC.

2. The system of claim 1, wherein the battery safety system includes one or more pyro drivers, each pyro driver configured to detonate a pyrotechnic device.

3. The system of claim 1, wherein the battery safety system includes a battery monitor.

4. The system of claim 1, wherein the first voltage domain and the second voltage domain have different nominal voltages.

5. The system of claim 1, wherein a nominal voltage of the first voltage domain is larger than a nominal voltage of the second voltage domain.

6. The system of claim 1, wherein the first voltage domain and the second voltage domain have different ground planes.

7. The system of claim 1, wherein the first voltage domain and the second voltage domain have nominal voltages less of than 50 volts.

8. The system of claim 1, further comprising a second DCDC configured to supply power to the second voltage domain from the high-voltage battery.

9. The system of claim 8, wherein the first DCDC is configured to supply power to both of the first voltage domain and the second voltage domain.

10. The system of claim 9, wherein a maximum sustained output power capacity of the second DCDC is at least ten times a maximum sustained output power capacity of the first DCDC.

11. The system of claim 1, further comprising a low voltage battery configured to supply power to the second voltage domain, the low voltage battery having a voltage of less than 50 volts at a full SOC.

12. The system of claim 1, further comprising a plurality of vehicle components coupled to the second voltage domain.

13. The system of claim 12, wherein the plurality of vehicle components includes at least one of actuators, lights, sensors, or controllers.

14. The system of claim 1, further comprising a capacitor in the first voltage domain, the capacitor configured to supply power to the battery safety system upon failure of the backup DCDC.

15. The system of claim 14, wherein the capacitor is connected to the second voltage domain and configured to supply power to the battery safety system through the backup DCDC.

16. A vehicle comprising:
a high-voltage battery having a voltage of at least 200 volts at a full state of charge (SOC);
one or more drive units configured to propel the vehicle via power received from the high-voltage battery;
a battery safety system configured to disconnect the high-voltage battery in response to an unsafe condition;
a first voltage domain, the battery safety system being in the first voltage domain;
a first direct current to direct current converter (DCDC) configured to supply power to the first voltage domain from the high-voltage battery;
a second voltage domain;
a second DCDC configured to supply power to the second voltage domain from the high-voltage battery;
a plurality of vehicle components coupled to the second voltage domain, the plurality of vehicle components including at least one of actuators, lights, sensors, or controllers; and
a backup DCDC configured to supply power from the second voltage domain to the first voltage domain in response to failure of the first DCDC.

17. The vehicle of claim 16, wherein the battery safety system includes one or more pyro drivers each configured to detonate a pyrotechnic device.

18. The vehicle of claim 16, wherein:
the first DCDC is configured to supply power to both of the first voltage domain and the second voltage domain; and
a maximum sustained output power capacity of the second DCDC is at least ten times a maximum sustained output power capacity of the first DCDC.

19. The vehicle of claim 16, further comprising a low voltage battery configured to supply power to the second voltage domain, the low voltage battery having a voltage of less than volts at a full SOC.

20. The vehicle of claim 16, further comprising a capacitor in the first voltage domain, the capacitor configured to supply power to the battery safety system upon failure of the backup DCDC, the capacitor being connected to the second voltage domain and configured to supply power to the battery safety system through the backup DCDC.
